(19) United States
(12) Patent Application Publication
(10) Pub. No.: US 2009/0271417 A1
(43) Pub. Date: Oct. 29, 2009

(54) Identifying User Relationships from Situational Analysis of User Comments Made on Media Content

(76) Inventors: John Toebes, Cary, NC (US); Guido Jouret, Mountain View, CA (US)

Correspondence Address: LEON R TURKEVICH, 2000 M STREET NW, 7TH FLOOR, WASHINGTON, DC, 200363307, US

(21) Appl. No.: 12/110,224

(22) Filed: Apr. 25, 2008

(51) Int. Cl. G06F 17/30

(52) U.S. Cl. 707/100; 707/E17.044

(57) ABSTRACT

In one embodiment, a method comprises detecting a first comment that is input by a first user at an instance coincident with the first user having been supplied a first identified position of a content asset; detecting a second comment that is input by a second user at an instance coincident with the second user having been supplied a second identified position of the content asset; and selectively establishing a similarity relationship between the first and second users, based on a determined positional similarity between the first and second comments based on the respective first and second identified positions relative to the content asset, and a determined content similarity between the first and second comments.

### TECHNICAL FIELD

The present disclosure generally relates to identifying relationships between users for filter-based searching of data available via information networks such as a wide area network (for example, the World Wide Web or the Internet), for example collaborative filtering.

### BACKGROUND

The exponential growth of information available to users of various information networks (for example, broadcast, satellite, or cable television; wide area networks such as the World Wide Web or the Internet), requires organizing the presentation of the available information in an efficient and effective manner. Collaborative filtering attempts to organize presentation of information to a user in a wide area network (for example, the World Wide Web) based on automatically predicting the interests of a user by establishing relationships between items of interest to the user (for example, items recently viewed by the user at a commercial website) and other items that have been determined as of interest to other users. Item-based collaborative filtering, illustrated for example at the website “amazon.com” (users who bought x also bought y) is based on the premise that if a number of users purchase both items “x” and “y”, then another user viewing (or purchasing) the item “x” also may be interested in the item “y”.

Demographic based targeting classifies individuals according to demographics, in an attempt to provide content that is considered more appropriate to the target individuals. For example, technologies such as Choicestream (available at the website address “choicestream.com”) use a series of questions to categorize people into a set of clusters based on similar responses to the questions. Conventional collaborative filtering systems can establish a relationship between online users “A” and “B” based on both users entering the same rating value (five stars) for the same item “X”. Such collaborative filtering techniques have been used to determine cohorts (i.e., a group of individuals having similar tastes). An example of fixed cohorts (using fixed demographic data) is illustrated for example by the Claritas Prizm Clustering by Claritas, Inc., San Diego, Calif. Other examples of utilizing collaborative filtering to classify a user into a similar group are provided by companies such as Revenue Science (at the website address “www.revenuescience.com”), Aggregate Knowledge (at the website address “aggregateknowledge.com”), and Wunderloop (at the website address “wunderloop.com”).

### BRIEF DESCRIPTION OF THE DRAWINGS

Reference is made to the attached drawings, wherein elements having the same reference numeral designations represent like elements throughout and wherein:

FIG. 1 illustrates an example system for executing socially collaborative filtering based on establishing user relationships for generation of recommendations personalized to a user's tastes, according to an example embodiment.

FIG. 2 illustrates an example execution of socially collaborative filtering for generation of the recommendations personalized to a user's tastes, according to an example embodiment.

FIG. 3 illustrates example item affinity values for a given user based on detecting socially relevant gestures representing user selection preferences, according to an example embodiment.

FIG. 4 illustrates example user affinity values provided by network users for a given network item, according to an example embodiment.

FIG. 5 illustrates users commenting on a content asset at positions of the content asset, according to an example embodiment.

FIG. 6 illustrates an example method for generating an affinity group based on establishing a relationship between at least two users based on situational analysis of their respective comments on a content asset, according to an example embodiment.

FIG. 7 illustrates examples database entries of the community database of FIG. 1 generated according to the method of FIG. 6, according to an example embodiment.

FIG. 8 illustrates an example implementation of the step in FIG. 6 of selectively generating a similarity value based on comparing positional similarity and content similarity between comments generated by respective users.

FIG. 9 illustrates example similarity relationships established between the comments generated by the users of FIG. 5 according to the method of FIG. 8, according to an example embodiment.

FIG. 10 illustrates an example affinity group established based on the similarity relationships of FIG. 9.

FIG. 11 illustrates an example method of identifying personally interesting content for a user based on establishing the affinity group of FIG. 10, according to an example embodiment.

### DESCRIPTION OF EXAMPLE EMBODIMENTS

### Overview

In one embodiment, a method comprises detecting a first comment that is input by a first user at an instance coincident with the first user having been supplied a first identified position of a content asset; detecting a second comment that is input by a second user at an instance coincident with the second user having been supplied a second identified position of the content asset; and selectively establishing a similarity relationship between the first and second users, based on a determined positional similarity between the first and second comments based on the respective first and second identified positions relative to the content asset, and a determined content similarity between the first and second comments.

In another embodiment, an apparatus comprises a processor circuit and a network interface circuit. The processor circuit is configured for detecting a first comment that is input by a first user at an instance coincident with the first user having been supplied a first identified position of a content asset, and detecting a second comment that is input by a second user at an instance coincident with the second user having been supplied a second identified position of the content asset. The processor circuit also is configured for selectively establishing a similarity relationship between the first and second users, based on a determined positional similarity between the first and second comments based on the respective first and second identified positions relative to the content asset, and a determined content similarity between the first and second comments. The network interface circuit is configured for outputting the similarity relationship for storage in a database.

### DETAILED DESCRIPTION

Particular embodiments disclosed herein enable the establishment of user relationships between users of a network, enabling the user relationships to establish affinity groups that cluster users into groups based on similar interests detected between the users. The particular embodiments detect comments that users input relative to consumption of a particular content asset, for example viewing a video stream supplied from playing a DVD owned by the user, or supplied by a media source via a network. The comments that are input by the users are analyzed not only with respect to the determined content similarity (for example, distinguishing favorable comments from unfavorable comments or neutral comments), but also with respect to the instance in which a user inputs a comment relative to the presentation of the content asset to the user.

In particular, the act of a user generating a comment at a specific instance relative to the content asset consumed by the user can demonstrate a substantially strong opinion or preference by the user with respect to the content that has just been consumed by the user at that particular position of the content. For example, assume a user is viewing a network content asset in the form of a sports event, a movie, a televised political debate, or an episode of a dramatic television series via a media stream downloaded from a network, or a content asset available from a local storage medium such as a DVD purchased by the user and supplied by a local DVD player that retrieves the media stream from the DVD: the user can have such a strong spontaneous and emotional reaction to a specific event presented in the media stream that the user submits a comment via the network to a destination, for example in the form of an instant message, a short message to a cell phone, or a message posting to an online bulletin board. Such a spontaneous and emotional reaction by the user to the specific event in the content asset can be recorded based on identifying not only the user and the user comment, but also the “position” of the content asset that is supplied to the user at the instant the user comment is detected. The term “position” can refer to a temporal position within the content asset (e.g., a timecode value within a media stream), or a spatial position within the content asset, for example in the case of a user reading an online book and submitting an online comment regarding a specific sentence, paragraph, and/or page of the online book. Hence, the spontaneous and emotional reaction by the user to the specific event and the content asset can be recorded based on detecting the instance the user inputs the comment, coincident with the position of the content asset that is being supplied for presentation to the user.

A similarity relationship can be established between users that spontaneously respond to the same event presented in the content asset based on determining the respective comments share a determined positional similarity relative to the content asset, for example based on identifying a substantially large number of comments that have been input within a ten-second interval relative to an identifiable timecode of a media stream. Hence, the similarity relationships can be established between multiple users that respond to the same event of the content asset, without analyzing the actual content of the event that caused the users to input their comments. Hence, the similarity relationships can be established without the necessity of performing any predictive analysis of the content asset.

Further, the similarity relationships can identify whether two users share the same affinity toward the same event in the content asset (for example, in the case of two fans of a sports team cheering a score by their sports team), or whether two users share an opposite affinity toward the same event in the content asset (for example, in the case of one fan cheering the event of a score by a sports team, while the other fan demonstrates opposition to the sports team by expressing dismay over the same event).

The establishment of the user relationships between users can be particularly effective in providing quality recommendations for content and advertising, since recommendations for a first user may be shared among other users that are deemed similar to the first user. Moreover, the establishment of the user relationships based on analyzing the positional similarity between the comments enables users to be categorized into different affinity groups based on their respective reactions to different positions of the content asset, even if all of the users having viewed the content asset express a favorable opinion or gesture of the overall content asset.

Hence, multiple affinity groups can be identified from a single content asset based on situational analyses of the comments submitted by the users having consumed at least a portion of the content asset, without the necessity of users viewing the entire content asset, or even without the necessity of any analysis of the content asset.

The particular embodiments disclosed herein thus can enhance the system of socially collaborative filtering described in commonly-assigned U.S. patent application Ser. No. 11/947,298, filed Nov. 29, 2007 and entitled “Socially Collaborative Filtering”, for determination of network items that are most likely to be preferred by a user. As described in further detail below, the particular embodiments disclosed herein improve the determination of network items, most likely to be preferred by a first user, based on establishing a similarity relationship between the first user and a second user based on respective comments made by the users relative to a network content asset, and identifying network items that are preferred by the second user.

Use of the term “network content asset” in this specification refers to online content that can be consumed by a user via the network (for example, online videos, music, e-books, online articles, written commentary, etc.). Use of the term “content asset” in this specification refers generally not only to a network content asset, but also to locally-stored content that can be consumed by the user and that can be indexed in the network, for example in the form of a data file stored on a tangible computer readable medium storage medium (for example, a compact disk (CD), a DVD, a nonvolatile memory card or portable disk drive), where the data file can have relevant metadata retrieved by a user device (for example, the personal computer 14b) and sent to the item database 26 for indexing. Relevant metadata can include an asset identifier (for example, DVD title or catalog identifier).

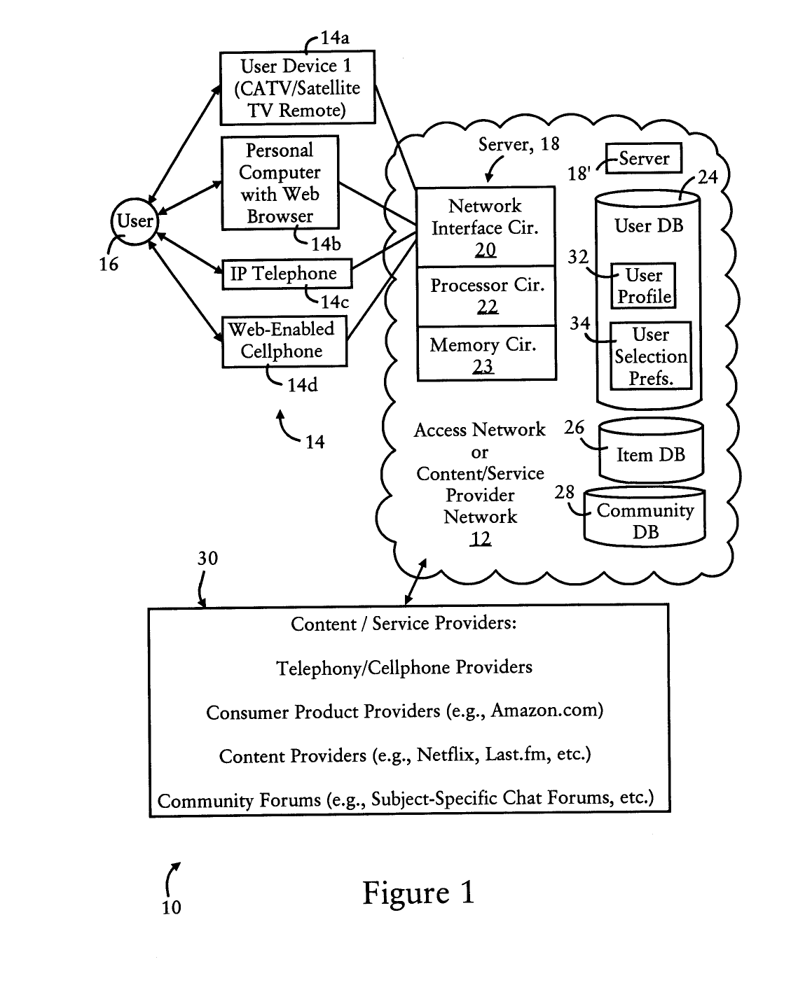

FIG. 1 illustrates an example system for establishing user relationships for socially collaborative filtering that generates recommendations personalized to a user's tastes, according to an example embodiment. The system 10 includes a network 12 configured for detecting user selection inputs from user devices 14 under the control of an identifiable user 16. Example user devices 14 can include a remote control 14a for an intelligent digital television system, a personal computer 14b having a web browser, an IP based telephone 14c (for example, a voice over IP telephone), and/or a web enabled cell phone 14d that can be configured for wireless voice over IP communications. The IP telephone 14c and the web-enabled cell phone 14d also can include a web browser.

Each of the user devices 14 can be configured for sending the user selection inputs to the network 12, either directly or via intermediate devices (for example, cable or satellite television set-top box configured for sending requests to the network 12; local access router at the customer premises, etc.) to a server 18 configured for responding to the user selection inputs by supplying recommended content back to the requesting user device 14.

The server 18 includes a network interface circuit 20 and a processor circuit 22. The network interface circuit 20 can be configured for receiving or detecting the user selection inputs from the user devices 14; the network interface circuit 20 also can be configured for accessing databases 24, 26, and/or 28, described below; network interface circuit 20 also can be configured for outputting personalized recommendations to the user devices 14, where the personalized recommendations can include at least one network item determined most likely to be preferred by the identified user 16 based on socially collaborative filtering executed by the processor circuit 22. The network item supplied to the user device can be implemented either as a reference (for example, a Uniform Resource Identifier (URI)) to the recommended content available from identifiable providers 30, or in the form of the actual content to be presented for consumption by the user 16 (i.e., consumed by the user) based on the server 18 retrieving the recommended content from the content or service providers 30. The personalized recommendations also can identify at least one content asset already stored locally on a user device (for example, a personal computer 14b) and that is indexed within the network 12, for example within any one of the databases 24, 26, or 28.

The example server 18 can be implemented as a single server that can be implemented at the head end of an access network 12 for a content provider offering content services to the user 16, the access network 12 providing access to other content or service providers 30 via a wide area network such as the Internet; alternately, the example server 18 can be implemented as a distributed server system within the network 12, where a first server (e.g., 18) within the distributed server system receives the user inputs and updates the user selection preferences, described below, and a second server (e.g., 18′) within the distributed server system determines and outputs personalized recommendations for the user 16 based on the updated user selection preferences; alternately, the first server (e.g., 18) can interact with the user by detecting user inputs and supplying recommendations of network items to the user, and a second (back-end) server (e.g., 18′) can generate the recommendations of the network items to be presented to the user, where either the first server or the second server can determine the socially relevant gestures from the user inputs. The example server 18 also can be implemented as part of a content provider network 30 that provides various services to the user 16 via a wide area network such as the Internet.

The example server 18 will be described herein within the context of a single, integrated server to simplify the description of the example embodiments. The operations described with respect to the server 18 also can be implemented in various forms, including a distributed server system implemented within an access network locally reachable by the user devices 14, or a distributed server system implemented within a content provider network that is remotely reachable by the user devices via a wide area network.

The server 18 can generate personalized recommendations for the user 16 based on executing socially collaborative filtering based on retrieval of information that can be stored in a user database 24, an item database 26, and/or a community database 28. The user database 24 can be configured for storing information related to the user 16, including a user profile 32 and user selection preferences 34. The user profile 32 can include information about the user 16, including personal account subscription information related to establishment and maintenance of any network service utilized by the network devices 14; the user profile 32 also can include identification of other network users that have a close relationship with the identified user 16 (i.e., known user-to-user relationships), for example “buddy lists” for instant messaging sessions or cell phone subscriptions, or users of online forums that the user 16 has identified as being “favorite” users or “disliked” users (as described below, these user-to-user relationships, or “buddy lists”, are distinct from similarity relationships because the similarity relationships can be established by the server 18 without any knowledge by the identified user 16 of any of the other users). The user selection preferences 34 can illustrate the socially relevant gestures of the identified user 16 based on an accumulation of the user selection inputs executed by the identified user 16 relative to the context of those user selection inputs (i.e., relative to other input options that were concurrently presented to the user with the input option that was selected by the user). As described below, the socially relevant gestures for the identified user 16 can be used to establish various relationships, for example user-item relationships that identify the network items for which the identified user 16 demonstrates having the highest affinity (i.e., preference).

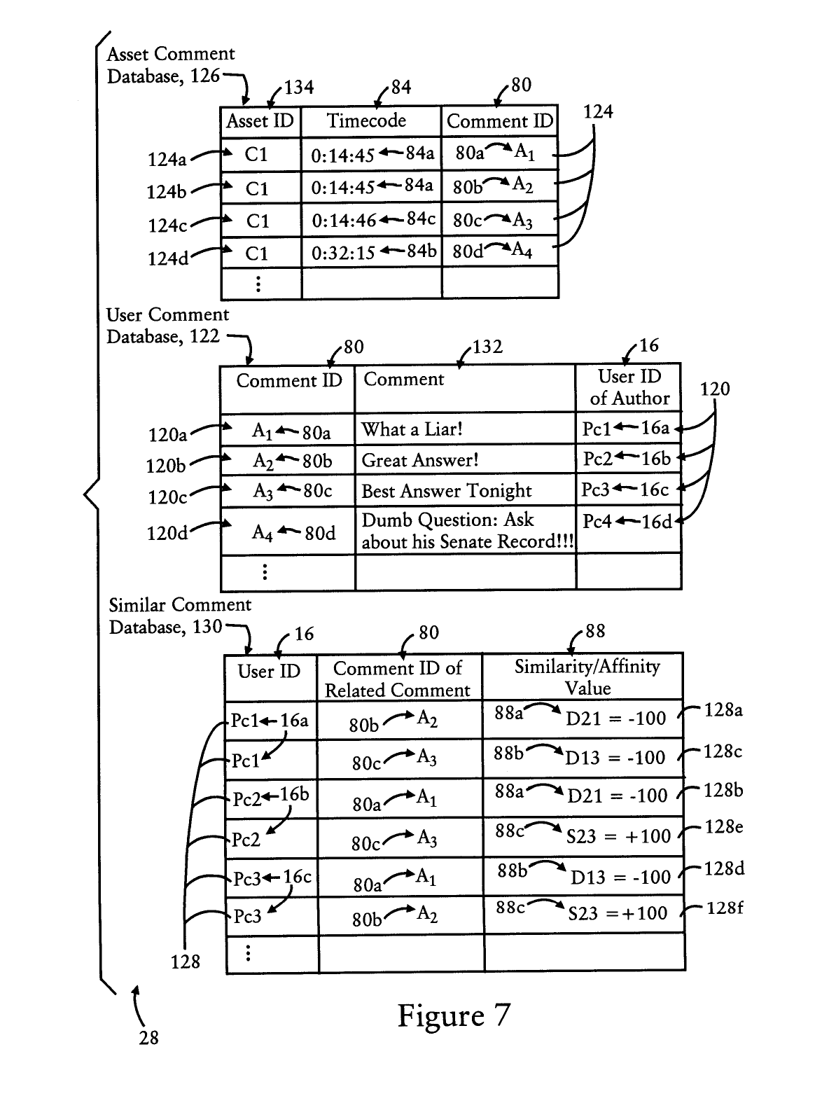

The item database 26 can be configured for storing information about network items that are available for presentation to the user, including item-to-item relationships and item-to-user relationships, described below. The community database 28 can include information identifying relationships between the identified user 16 and other elements of a community-based network service, for example messaging boards, Internet-based recommendation sites, Internet-based social community websites, etc., where the identified user 16 can identify himself or herself as having particular preferences in terms of political interests, hobbies, “favorite” users, “disliked” users, preferred content, or content to avoid. The community database 28 is described in further detail with respect to FIG. 7.

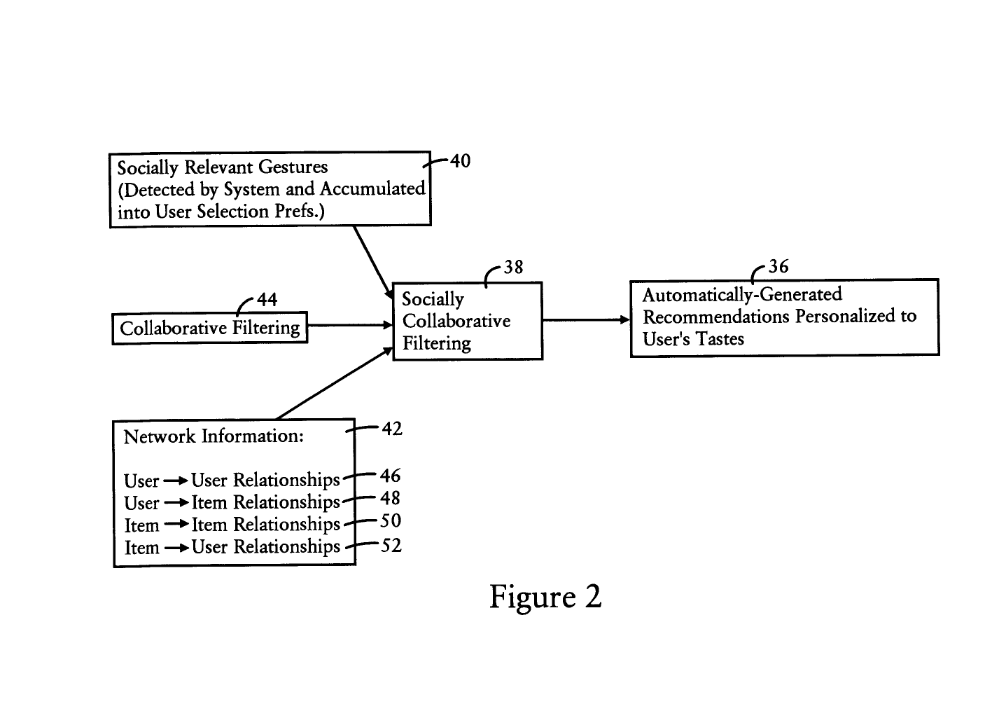

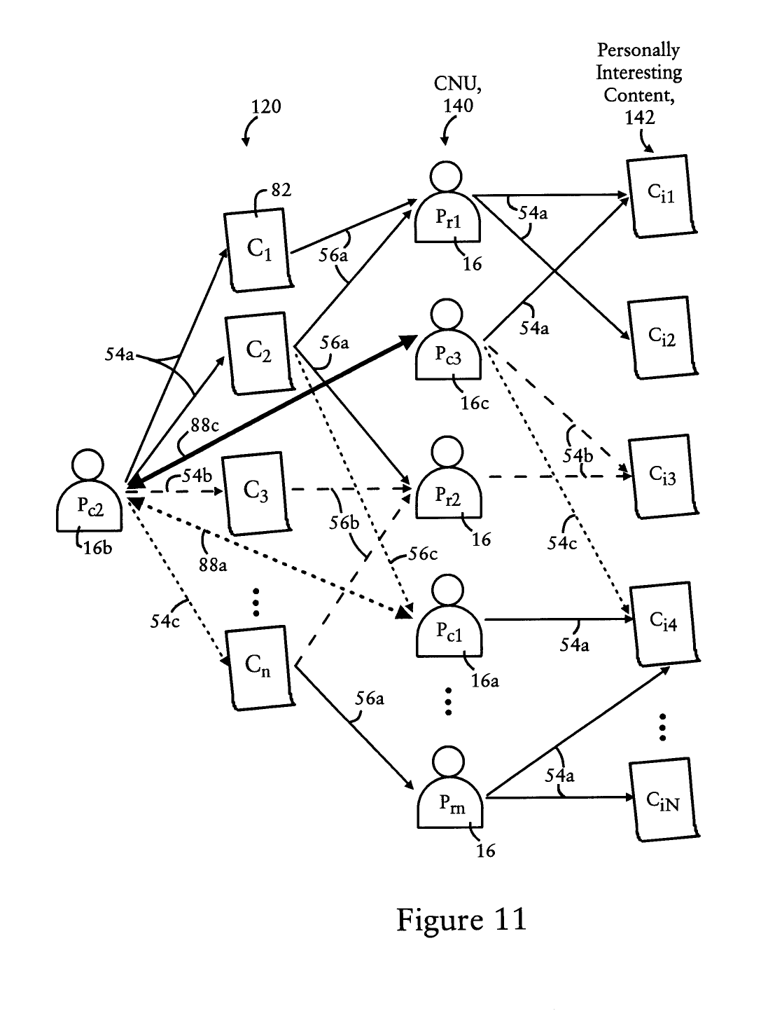

FIG. 2 illustrates a summary example execution of socially collaborative filtering by the processor circuit of FIG. 1, according to an example embodiment. As described below, the processor circuit 22 can access any one of the databases 24, 26, and/or 28 in order to determine a list 36 of recommendations of network items that would most be preferred by the identified user 16 based on execution of socially collaborative filtering 38 by the processor circuit 22. As described in detail below with respect to FIG. 11, the processor circuit 22 can execute socially collaborative filtering 38 based on applying the socially relevant gestures 40 exhibited by the user selection preferences 34 to available network information 42 using collaborative filtering techniques 44.

The network information 42 can include one-way relationships that demonstrate affinities of a given network object toward another network object. For example, the network information 42 can include one-way user-user relationships 46, one-way user-item relationships 48, one-way item-item relationships 50, and one-way item-user relationships 52. As described below, the processor circuit 22 can determine each of the relationships 46, 48, 50 and 52 based on socially relevant gestures 40, and store the relationships 46, 48, 50 and 52 in an appropriate database 24, 26, or 28 for future use, for example updating the relationships 46, 48, 50, or 52 in response to additional detected socially relevant gestures.

The user-to-user relationships 46, which can be determined and stored by the processor circuit 22 in the user profile 32 and/or the community database 28, can demonstrate specific affinity determined by the processor circuit 22 between one person toward another person, where a given person (A) can have a strong affinity toward another person (B) based on a close personal or business relationship, whereas the second person (B) may demonstrate a lesser affinity toward the first person (A) for example in the case of a manager or popular individual (B) being admired by the other person (A). Hence, the users A and B can demonstrate asymmetric (i.e., unequal) affinity values toward each other. The user-to-user relationships 46 typically are updated only when the relevant user (for example, A) establishes or updates (for example, modifies or deletes) the relationship with the other user (B); hence, the user-to-user relationships 46 are not updated as a result of the user (A)'s interactions with network items.

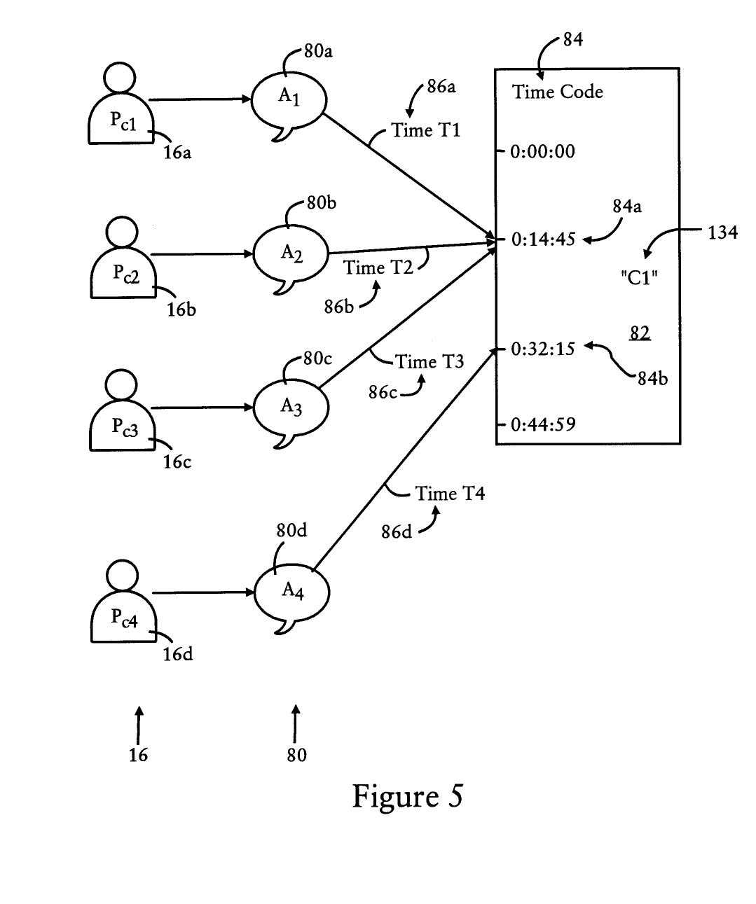

As described below with respect to FIGS. 5-11, the server 18 also can add similarity relationships 88 to the user-to-user relationships 46 within the community database 28, based on establishing the similarity relationships between users based on detecting socially relevant gestures 40 in the form of comments input by the users relative to a content asset. As described in further detail below, the content asset against which user comments are analyzed can be a network content asset supplied via the network 12, or a content asset that is available locally to the user 16 and that has metadata supplied by a local device (for example, computer 14b) to an identifiable destination such as the server 18.

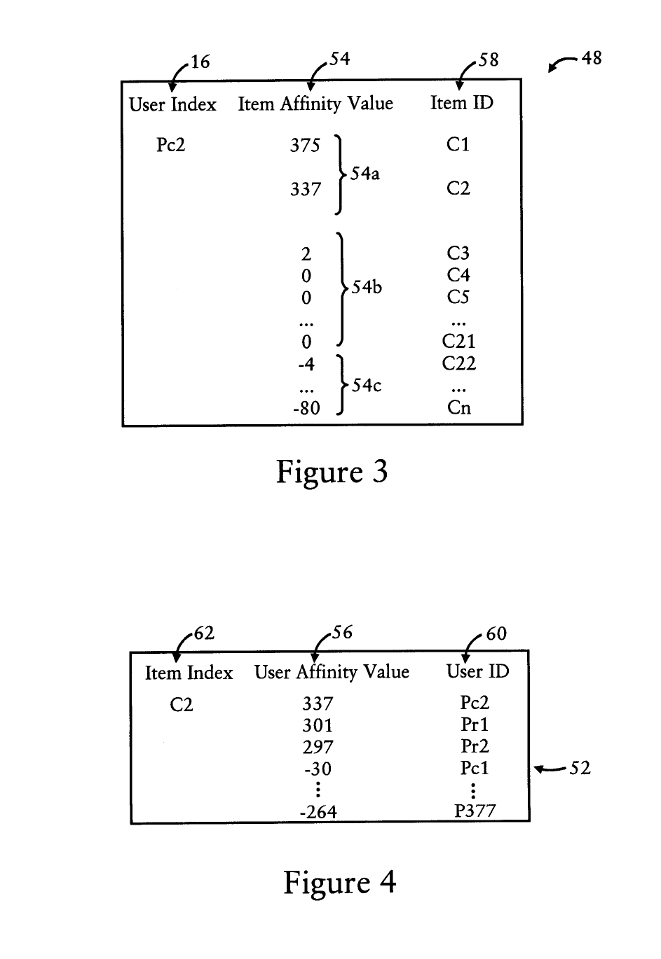

The user-item relationships 48, stored for example by the processor circuit 22 in the user selection preferences 34 and illustrated below with respect to FIG. 3, can demonstrate specific affinity values generated by the processor circuit 22 and that represent the available network items 58 presented to the user 16 for which the corresponding user 16 has expressed the greatest interest or affinity: the specific affinity values that demonstrate the relative affinity or “strength” of the user-item relationships 48 are illustrated in FIG. 3 as “item affinity values” 54.

The item-item relationships 50, which can be generated and stored by the processor circuit 22 in the item database 26, can demonstrate predetermined relationships between distinct network items, for example: relationships established between products and different accessories (for example, battery charger for a cellphone or other battery-operated device); relationships between similar video content based on the same actors, actresses, directors, etc.; music written and performed by the same performer, etc.. The item-item relationships 50 also can demonstrate relationships determined by the processor circuit 22 based on analysis of network content and performing comparisons between network items. An example item-item relationship 50 can be expressed by an e-commerce website that presents a product “X” with a related product “Y” with the description that individuals who purchased “X” also purchased “Y”. Example techniques for implementing item-item relationships 50 include domain specific knowledge: examples of implementing domain specific knowledge include the commercially available filtering offered by ChoiceStream (at the website address “choicestream.com”), which determines equivalents between movies, or ExpertSystems technology for determining similarity between concepts in text based content. Use of the item-item relationships 50 by the processor circuit 22 enables more efficient and faster determination of equivalence for new content (i.e., new network items) that are added to (i.e., made available to) the system 10. Such relationship analysis can be performed at any time, including when the network items are added to the system 10, when any user accesses the network items, or during background scans of content within the system 10.

The item-user relationships 52, which can be determined and stored by the processor circuit 22 in the item database 26, can demonstrate, for a given item, the relative affinity or “strength” of network users determined by the processor circuit 22 to a given item: the specific affinity values that demonstrate the “strength” of the item-user relationships 52 are illustrated in FIG. 4 as “user affinity values” 56, where the network users having the strongest affinity toward a given item 62 (based on their corresponding item affinity value 54) are identified within the item-user relationships 52. Hence, each item-user relationship 52 has a corresponding “mirroring” (i.e., converse) user-item relationship 48. Use of distinct databases for the relationships 48 and 52 provide more efficient mapping, although it is foreseeable that a single database could be used to construct the relationships 48 and 52, regardless of the direction of the mapping.

Any of the disclosed circuits of the server 18 (including the network interface circuit 20, the processor circuit 22, and the memory circuit 23 and their associated components) can be implemented in multiple forms. Example implementations of the disclosed circuits include hardware logic that is implemented in a logic array such as a programmable logic array (PLA), a field programmable gate array (FPGA), or by mask programming of integrated circuits such as an application-specific integrated circuit (ASIC). Any of these circuits also can be implemented using a software-based executable resource that is executed by a corresponding internal processor circuit such as a microprocessor circuit (not shown), where execution of executable code stored in an internal memory circuit (for example, within the memory circuit 23) causes the processor circuit to store application state variables in processor memory, creating an executable application resource (for example, an application instance) that performs the operations of the circuit as described herein. Hence, use of the term “circuit” in this specification refers to both a hardware-based circuit that includes logic for performing the described operations, or a software-based circuit that includes a reserved portion of processor memory for storage of application state data and application variables that are modified by execution of the executable code by a processor. The memory circuit 23 can be implemented, for example, using a non-volatile memory such as a programmable read only memory (PROM) or an EPROM, and/or a volatile memory such as a DRAM, etc..

Further, any reference to “outputting a message” or “outputting a packet” (or the like) can be implemented based on creating the message/packet in the form of a data structure and storing that data structure in a tangible memory medium in the disclosed apparatus (for example, in a transmit buffer). Any reference to “outputting a message” or “outputting a packet” (or the like) also can include electrically transmitting (for example, via wired electric current or wireless electric field, as appropriate) the message/packet stored in the tangible memory medium to another network node via a communications medium (for example, a wired or wireless link, as appropriate) (optical transmission also can be used, as appropriate). Similarly, any reference to “receiving a message” or “receiving a packet” (or the like) can be implemented based on the disclosed apparatus detecting the electrical (or optical) transmission of the message/packet on the communications medium, and storing the detected transmission as a data structure in a tangible memory medium in the disclosed apparatus (for example, in a receive buffer). Also note that the memory circuit 23 can be implemented dynamically by the processor circuit 22, for example based on memory address assignment and partitioning executed by the processor circuit 22. In addition, the processor circuit 22 can be implemented as a multi-processor system or based on a distributed server system.

FIG. 5 illustrates an example of multiple users 16 submitting respective comments 80 in response to the users 16 consuming at least a portion of a content asset (e.g., “C1”) 82, according to an example embodiment. As described previously, the content asset 82 can be implemented as an audio or video media stream, an online electronic document, etc. The content asset 82, illustrated in FIG. 5 as a media stream “C1”, can be characterized as including a sequence of position identifiers 84 that can be implemented in the form of a timecode sequence, frame sequence, ten-second interval sequence, etc.

As illustrated in FIG. 5, the users 16a, 16b, and 16c each respond to a particular event having occurred within the content asset 82 at the timecode “0:14:45” 84a of the content asset 82, for example a sports team having scored during a championship sports event, a controversial answer given by a contestant in a political debate, or a dramatic scene in a movie presented to any one of the users 16a, 16b, or 16c either via a download from the network 12 or a locally-owned DVD. Each of the users 16a, 16b, and 16c respond to the event at the timecode “0:14:45” by inputting a corresponding comment 80: for example, the first user 16a can input a comment 80a at a time instance “T1” 86a using one of the user input devices 14 of FIG. 1; the second and third users 16b and 16c also can input respective comments 80b and 80c at the respective time instances “T2” 86b and “T3” 86c using one of their respective input devices 14. As illustrated in FIG. 5, the user 16d does not respond to the content asset 82 until the time instance “T4” 86d in response to a particular event having occurred within the content asset 82 at the timecode “32:15” 84b.

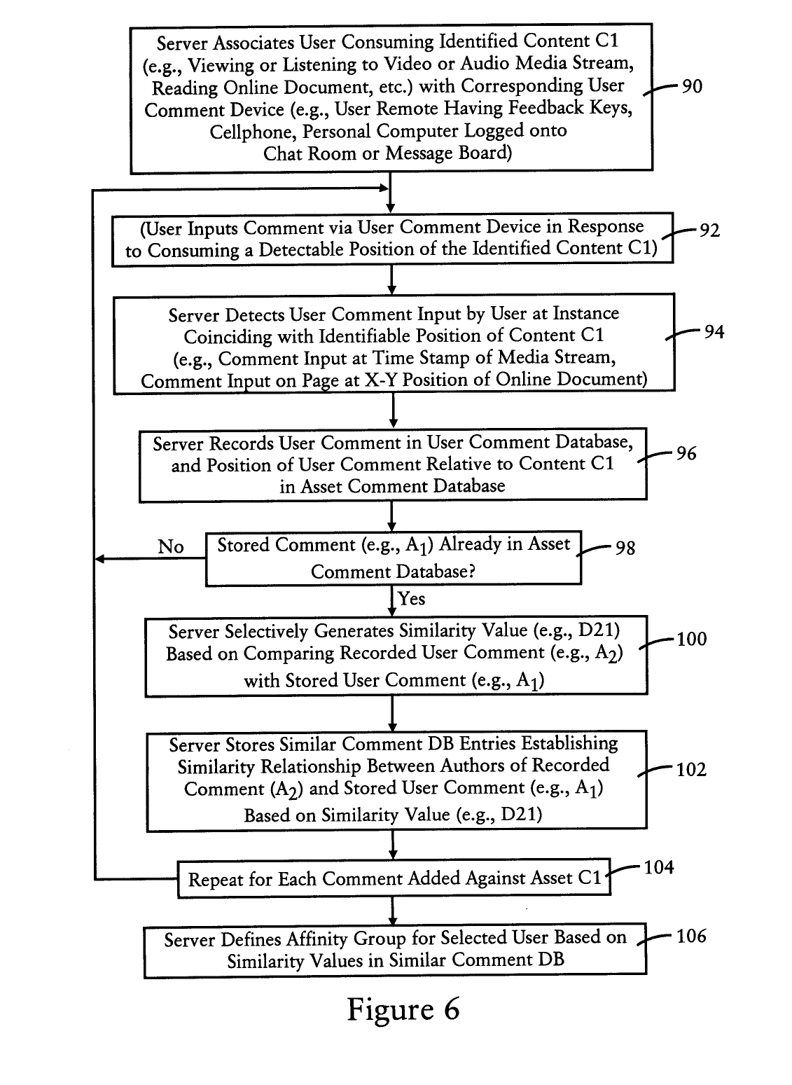

As described below with respect to FIGS. 6-11, the processor circuit 22 within the server 18 of FIG. 1 can selectively establish a similarity relationship between the users 16a, 16b, and 16c based on the respective users inputting the respective comments 80a, 80b and 80c at the respective instances 86a, 86b, and 86c coincident with the users 16a, 16b, and 16c having been presented with the identified position 84a of the content asset 82. In particular, the processor circuit 22 associates the input of the comments 80 at the respective time instances 86 to the position(s) 84 of the content asset 82 presented to the users 16, enabling the respective instances 86 to represent the respective positions in which the users consumed the content asset 82. Consequently, the comments 80 (e.g., 80a, 80b, and 80c) that “congregate” around a locus of a particular position 84 (e.g., 84a) are deemed to be highly relevant to the event that occurred at the particular position, whereas any comment (e.g., 80d) that is further from the locus (e.g., 84a) of a particular position of the content asset 82 is deemed to be less relevant to the event that occurred at the particular position.

In addition, the comments that congregate around a locus of a particular position 84 can be analyzed to determine whether the comments share a similar affinity (e.g., a similar comment or opinion), or whether the comments share opposite affinities (e.g., opposite opinions). Hence, the situational analysis of the comments based on position 84 relative to the instance 86 that the comment 80 was generated, as well as the content of the comments 80, enable the establishment of similarity relationships between the authors of the comments.

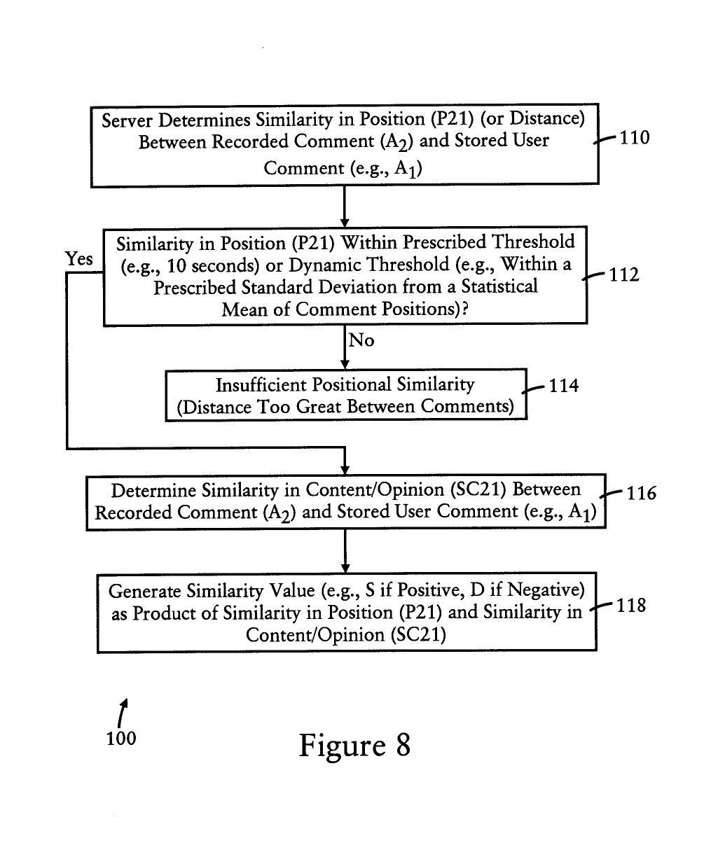

FIG. 6 illustrates an example method by the server 18 of FIG. 1 of establishing similarity relationships 88 (illustrated in FIGS. 7 and 9-11) between users 16 based on determined positional similarities and content similarities of respective comments 80, according to an example embodiment. The similarity relationships 88 can be used for generating the recommendations 36 (142 in FIG. 11) personalized to a user's tastes based on execution of socially collaborative filtering 38, according to an example embodiment. The steps described in FIG. 6, as well as the steps described below with respect to FIGS. 8-11, can be implemented as executable code or encoded logic stored on a computer readable medium (for example, floppy disk, hard disk, ROM, EEPROM, nonvolatile RAM, CD-ROM, etc.) that are completed based on execution of the code by a processor; the steps described herein also can be implemented as executable logic that is encoded in one or more tangible media for execution (for example, programmable logic arrays or devices, field programmable gate arrays, programmable array logic, application specific integrated circuits, etc.).

As illustrated in FIG. 6, the server 18 of FIG. 1 associates in step 90 the users 16 consuming the identified content asset 82 with a corresponding user comment device 14 that can be used by the corresponding users 16 for supplying an input 80. For example, the server 18 can identify that the content 82 is supplied by a media server (not shown) in the network 12 to each of the users 16 based on the users 16 having purchased a subscription for the content 82 in the form of a pay-per-view event (live or pre-recorded), as well as based on receiving media traffic information identifying each of the users 16 that are being presented with the network content asset 82 via their respective presentation devices, for example an IP enabled cable or satellite set-top box. The server 18 also can associate the media stream 82 to the corresponding user comment device 14, for example based on the corresponding user 16 registering his or her user device 14 to provide commentary for the content asset 82 presented to the user 16. As apparent from FIGS. 1 and 6, various types of user comment devices can be employed, for example a user remote 14a having feedback keys, a cell phone, a personal computer 14b that is logged into a chat room or message board related to the content asset 82, etc. Also note that various feedback keys on the user comment device 14 can be used to identify predetermined positive or negative comments. The processor circuit 22 of the server 18 also can perform the association in step 90 automatically, for example based on automatically associating a user remote 14a as the user comment device in response the user remote 14a being employed to request presentation of the content asset 82.

As described below with respect to step 94, the server 18 also can associate the content asset 82 with the user 16 based on receiving a message from a user device 14 (for example, the personal computer 14b) that includes metadata identifying the content asset 82, for example in the case of the content asset 82 retrieved by the user device from a local tangible storage medium such as a DVD purchased by the user 16.

Once the processor circuit 22 has associated the user comment device 14 with the content asset 82 that is supplied to the corresponding user 16, the processor circuit 22 can apply any comments 80 generated by a user 16 toward the content asset 82 being supplied to the corresponding user 16. As will be apparent from the description herein, it is not necessary that any user 16 consume the content asset 82 in its entirety; to the contrary, since the similarity relationships 88 are established based on the positional similarity between comments 80 and independent of the actual content of the content asset 82, the similarity relationships 88 can be established based upon any user 16 commenting on any arbitrary portion of the content asset 82, for example based on the user viewing only a five second replay of a sports team having scored a goal in a championship game, or a particular event of a movie presented via a DVD.

In addition, it is not necessary that all users 16 consume the content asset 82 at the same time; to the contrary, the positional similarity is based upon comparing the instances the comments are input relative to the content positions 84 presented to the users writing the comments, not the time that the content asset 82 is presented to a user. Hence, the same content asset 82 can be presented to different users at different times, where each comment 80 input by a user 16 is identified based on associating the corresponding instance 86 that the comment 80 is input with the relative position 84 presented to the user 16.

Assume in step 92 of FIG. 6 that a user (e.g., 16a) of FIG. 5 inputs a comment (e.g., 80a) via his registered user comment device 14 in response to consuming (e.g., viewing or listening to) an event that occurred at a detectable position 84a of the identified content 82, for example in response to the content 82 displaying at the position 84a a sports team having scored a goal, or in response to the content 82 displaying at the position 84a a controversial answer by a contestant in a political debate. As illustrated in FIG. 5, the user 16a inputs the comment 80a at the time instance 86a that coincides with the presentation by the network 12 to the user 16a of the position 84a of the content asset 82.

The processor circuit 22 in the server 18 can detect in step 94 the comment 80a input by the user 16a at the instance 86a coinciding with the identifiable position 84a presented to the user 16a. As illustrated in FIG. 6, the position 84 of the content asset 82 can be identified depending on the type of asset that is being delivered; for example the position 84 can be implemented as a timestamp or timecode of a media stream, the position 84 also can be implemented within an electronic document as any one of a paragraph of the electronic document, a line of the electronic document, a page of the electronic document, an X-Y coordinate position, or any combination thereof. If the content asset 82 is presented to the user 16a in the form of a media stream via the network 12, and assuming no time stamp value is supplied with the comment 80a identifying the time instance 86 that the comment 80a was generated, the processor circuit 22 can correlate the time instance 86 that the comment 80a is generated (detected for example based on the time of receipt by the processor circuit 22) with the relative position 84 of the media content 82 presented to the user 16a; for example, the processor circuit 22 can send a query to a media server (not shown) supplying the content asset 82, to determine the time code 84 identifying the portion of the corresponding content asset 82 supplied by the media server to the user 16a at the time instance 86a.

If the content asset 82 is presented to the user 16a in the form of a media stream obtained by a local device 14 (for example, the personal computer 14b) from a local source, for example a DVD, the local device 14 in step 92 can send to the server 18 a message that includes metadata identifying the content asset 82, the comment 80a, and the position 84a presented to the user 16a and identified by the local device 14 as coinciding with the time instance 86a that the local device 14 detected the comment 80a input by the user 16a.

In response to detecting in step 94 the comment 80a input by the user 16a at instance 86a, the processor circuit 22 of the server 18 can record in step 96 the comment 80a as a user comment entry 120 into a user comment database 122, illustrated in FIG. 7. The processor circuit 22 also can record in step 96 the relative position 84a of the content asset 82 coinciding with the instance 86a that the user input the comment 80a, based on creating an asset comment entry 124a within an asset comment database 126, illustrated in FIG. 7.

FIG. 7 illustrates an example of databases 122, 126, and 130 stored within the community database 28 of FIG. 1, according to an example embodiment. As illustrated in FIG. 7, the processor circuit 22 can record in step 96 the user comment 80a by storing a user comment entry 120a specifying the corresponding comment identifier 80a as illustrated in FIG. 5, a corresponding content indicator 132 of the comment 80a (expressed for example as comment text, or a digital value of “1” indicating a favorable opinion or “0” indicating an unfavorable opinion), and a user identifier 16 identifying the author that input the corresponding comment 80a. As illustrated in FIG. 7, the content indicator 132 can specify the actual comment text that is input by the corresponding user 16a.

The processor circuit 22 also stores in step 96 an asset comment entry 124 that identifies that the corresponding comment 80a was input at a time instance 86a coincident with the user 16a being presented with (i.e., supplied with) an identified position 84a of the asset 82, where the asset 82 is identifiable by its asset identifier (“C1”) 134. Hence, the processor circuit 22 records in step 96 the comment-specific attributes of the user comment 80a within the user comment entry 120a, and the positional context of the user comment 80a relative to the asset 82 presented to the user 16a within a corresponding asset comment entry 124a. The processor circuit 22 can repeat each of the steps 94 and 96 for each comment 80 that is input by any user 16 in step 92, resulting in a corresponding entry 120 and 124 for each comment 80. As illustrated in FIGS. 5 and 7, the processor circuit 22 records in entries 124a and 124b that the respective comments 80a and 80b have the same position 84a relative to the timecode that is implemented for the content asset 82; in contrast, the processor circuit 22 records in the entry 124c that the comment 80c is input by the user 16c at a time instance 86c that is coincident with the user 16 being presented with a position 84c of the content asset 82, namely one second after the comments 80a and 80b have been input by the respective users 16a and 16b. Finally, the processor circuit 22 records in the entry 124d that the comment 80d by the user 16d is input at the time instance 86d that is coincident with the user 16d being presented with position 84b of the content asset 82. Comment-specific attributes for the comments 80b, 80c, and 80d also are stored in the respective entries 120b, 120c, and 120d.

The processor circuit 22 can begin determining the presence of similarity relationships 88 in step 100 upon detecting at least two comments stored within the asset comment database 126 in step 98. Hence, the processor circuit 22 can selectively generate similarity values 88 in step 100 in “real time” as the comments 80 are being generated. Alternately, the processor circuit 22 can selectively generate the similarity values 88 in step 100 after presentation of the content asset 82 to the users 16 has been completed. Also note that the operations described with respect to FIG. 6 can be partitioned among multiple servers, such that a first server 18 in the network 12 can execute steps 94, 96, and 98 for population of the databases 122 and 126, and a second server (e.g., 18′) can selectively establish the similarity values 88 based on detecting the comments 80 by monitoring for new entries 120 and/or 124 in the user comment database 122 and/or the asset comment database 126.

FIG. 8 illustrates example steps for implementing the step 100 of FIG. 6 of the server 18 (or 18′) selectively generating similarity values 88 establishing similarity relationships between users 16, according to an example embodiment. The processor circuit 22 of the server 18 can begin comparison between comments associated with the asset 82 as soon as at least two comments 80 (e.g., 80a and 80b) have been detected as associated with the content asset 82, for example in response to the network interface circuit 20 detecting reception of the corresponding comment 80 during “real-time” situational analysis, or in response to the processor circuit 22 detecting the storage in the community database 28 of an additional entry 120 and/or 124.

Assuming the processor circuit 22 is configured for performing “real-time” situational analysis, the processor circuit 22 can begin situational analysis in step 100 after having stored into the community database 28 the user comment entry 120b and the asset comment entry 124b for the user comment 80b, referred to as the “recorded comment” with reference to FIG. 8. As illustrated below, each newly recorded comment can be compared against every other stored comment in the user comment database 122 and asset comment database 126 associated with the content asset 82; alternately, database optimization algorithms can be employed that reduce the number of records that need to be analyzed. In this example, the processor circuit 22 can retrieve the information for a “stored” user comment (e.g., 80a) based on initiating retrieval of the first asset comment entry 124a stored in the asset comment database 126 indexed by the asset identifier (“C1”) 134 of the content asset 82 against which the comments 80 are generated.

The processor circuit 22 can begin situational analysis of the recorded comment 80b relative to the stored comment 80a based on first determining in step 110 a positional similarity in the respective positions 84a specified in the respective asset comment entries 124a, 124b, where the positional similarity (e.g., “P21”) between the two comments 80a and 80b is inversely proportional to the “distance” between the respective positions 84a and 84b. As apparent from the foregoing, the positional similarity (or the inverse distance value) can be determined depending on how the position 84 is implemented, for example whether the position value 84 is implemented as a timecode value, a paragraph number of a text document, page number, etc. In the examples illustrated in FIGS. 5 and 7, the positional values 84a and 84b can be illustrated as timecode values; hence, the distance can be determined simply by subtracting the values.

The processor circuit 22 can determine in step 112 whether the similarity in position (P21) between the two comments 80a, 80b under analysis falls within an identifiable threshold, for example a prescribed fixed threshold (e.g., 10 seconds), or a dynamic threshold that can be established based on a population of stored comments. For example, if a statistically significant number of comments 80 have been recorded relative to the content asset 82, a dynamic threshold based on a population of stored comments can be determined statistically, for example based on identifying from the asset comment database 126 at least one position 84 having a statistically significant number of comments that are “congregated” around the one position; hence, if a significant number of comments are “congregated around a given position 84, the “center” can be determined as the statistical mean of comment positions for a given collection or congregation of comments, and the dynamic threshold can be based on a prescribed standard deviation from the statistical mean. As apparent from the foregoing, other techniques can be employed to determine in step 112 whether the similarity in position between two comments falls within an acceptable threshold used to define whether there is a sufficient positional similarity between the two comments under analysis.

If in step 112 the processor circuit 22 determines the similarity in position does not fall within the determined threshold, the processor circuit 22 concludes in step 114 there is insufficient positional similarity between the two comments, and continues to the next comment without establishing any relationship between the two comments because the positional distance is too great between the two comments.

Assuming in step 112 that there is sufficient positional similarity based on the similarity in position falling within the desired threshold, the processor circuit 22 can calculate in step 116 the relative similarity in content or an opinion (SC21) between the recorded comment 80b and the stored comment 80a. In particular, the processor circuit 22 analyzes the respective comment content indicators 132 to determine whether they express similar content or opinions. Various recognition schemes can be employed, depending on the manner in which the comment content indicators 132 are implemented. For example, if the users 16 utilize a user device (e.g., 14a) that provide a predetermined set of feedback buttons (e.g., yes/no, buttons 1-5 for a 5-star rating system, etc.), the processor circuit 22 can determine the similarity between the comments based on this correlating the buttons that were pressed; if the comment content indicators 132 include text, various text and context correlation techniques can be employed, including semantic analysis technology that determines a taxonomy of the comment which is made. An example semantic analysis technology that can be implemented is the commercially available system from Expert System Cogito (available at the website address “www.expertsystem.net/page.asp?id=1521”).

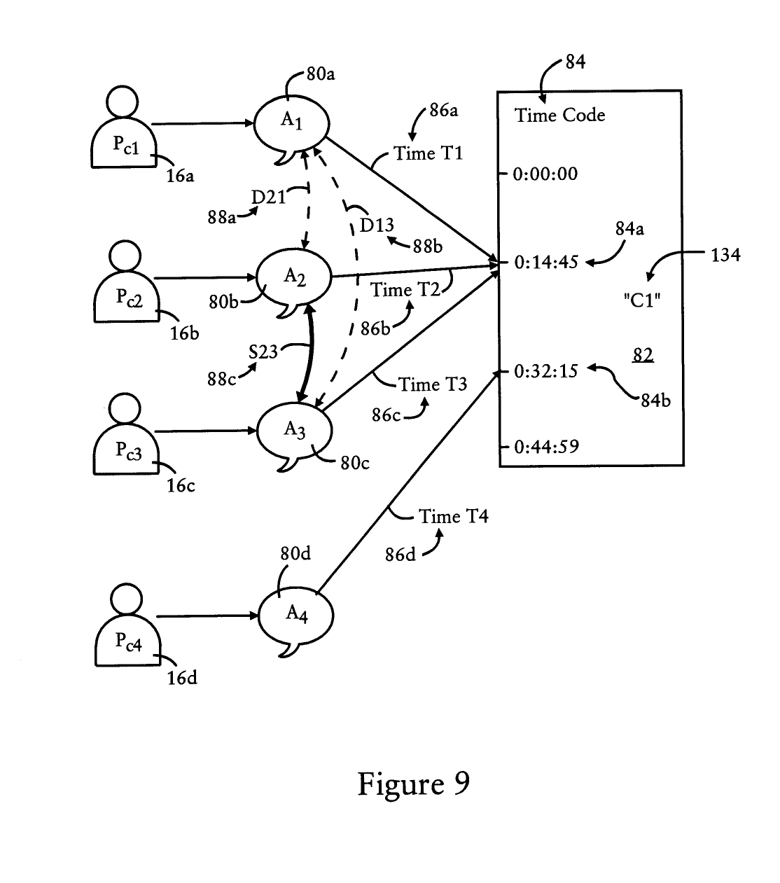

In response to the processor circuit 22 calculating in step 116 the similarity in content (SC21) between the recorded comment 80b and the stored comment 80a, the processor circuit 22 can generate in step 118 a similarity value (e.g., “D21”) 88 that establishes a similarity relationship between the comments 80a and 80b, illustrated in FIG. 9 as the similarity relationship 88a. For example, FIG. 8 illustrates that the similarity value 88 can be calculated as a product of multiplying the similarity in position (P21) between the comments 80a and 80b with the similarity in content (SC21) between the comments 80 and 80b. As illustrated in FIG. 7, the comment content indicator 132 of the user comment entry 120a illustrates that the user 16a expressed an extremely negative comment 80a in response to the event occurring at the corresponding position 84a in the content asset 82; in contrast, the comment content indicator 132 of the user comment entry 120b indicates that the user 16b expressed an extremely positive comment 80b in response to the event occurring at the same position 84a; hence, the strong positional similarity (e.g., P21=10) coupled with the strongly opposing opinions generating a strongly negative similarity content value (e.g., SC21=−10) can result in a strongly negative similarity value (D21=−100) 88a that demonstrates that the comments 80a and 80b reflects strongly opposing viewpoints with respect to the same event at the position 84a of the content asset 82.

Referring to FIG. 6, the processor circuit 22 in the server 18 can store in step 102 a similarity entry 128 in a similar comment database 130 within the community database 28, for example based on the network interface circuit 20 outputting the similarity relationship 88 for storage and the similar comment database 130. As illustrated in FIG. 7, the similar comment database 130 can be configured for storing multiple similarity entries 128, indexed by a user having generated a comment, that define relationships 88 between a given user (e.g., 16a) and a related comment (e.g., 80b) by another user, based on the corresponding similarity value 88 generated as described above with respect FIG. 8. For example, the similarity value 88a generated by the processor circuit 22 in response to the comparison of the comments 80a and 80b in step 100 as illustrated in FIGS. 6 and 8 causes the processor circuit 22 to store in step 102 the entries 128a and 128b that identify the same similarity value (“D21=−100) 88a illustrated in FIG. 9. As described below with respect to FIG. 11, the similar comment database 130 has the similarity entries 128 indexed by user identifier in order to optimize identification of user affinity groups for a given user. Hence, the processor circuit 22 generates and adds the similarity entries 128a and 128b in response to generating the similarity relationship 88a between the comments 80a and 80b, where the similarity entry 128a indexed for the first user 16a identifies the related comment 80b authored by the second user 16b and having the similarity relationship 88a, and the similarity entry 128b indexed for the second user 16b identifies the related comment 80a authored by the first user 16a and having the similarity relationship 88a.

The processor circuit 22 repeats in step 104 the steps of FIG. 6 for each comment 80b that is input by any user relative to the registered content asset 82. Hence, the processor circuit 22 can establish the similarity relationship 88b based on comparing the recorded comment 80c with the stored comment 80a, where despite the respective comments 80a and 80c having a relatively high positional similarity (e.g., P13=10) based on the respective positions 84a and 84c as identified from the asset comment entries 124a and 124c, the processor circuit 22 determines from the comment content indicators 132 of the respective entries 120a and 120c that the respective comments 80a and 80c express strongly opposing opinions (e.g., SC13=−10), resulting in a strongly negative similarity relationship (D13=−100) 88b. Hence, the processor circuit 22 can add the similarity entries 128c and 128d for the users 16a and 16c in response to generating the similarity value 88b.

The processor circuit 22 also can establish the similarity relationship 88c based on comparing the recorded comment 80c with the stored comment 80b, resulting in a relatively high positional similarity (e.g., P32=10) and a high content similarity (SC23=10) that create the similarity relationship (S23=100) 88c. Hence, the processor circuit 22 can add the similarity entries 128e and 128f for the respective users 16b and 16c in response to generating the similarity relationship 88c.

In contrast, the processor circuit 22, in response to detecting from the asset comment entry 124d the comment 80d by the user 16d, concludes in steps 112 and 114 of FIG. 8 that the comment 80d has insufficient positional similarity relative to the comments 80a, 80b, and 80c, and therefore determines that no similarity relationship should be established between the comment 80d and any of the comments 80a, 80b, or 80c.

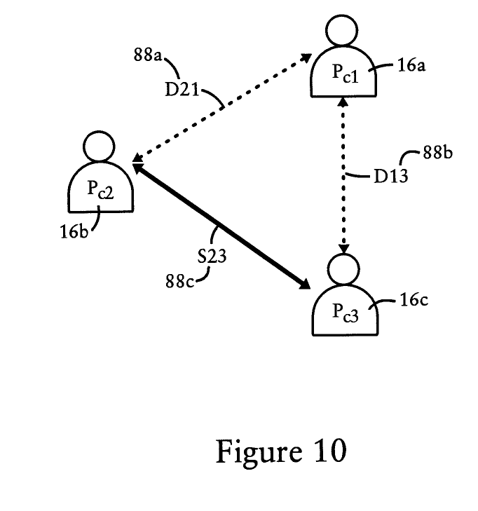

As illustrated in FIGS. 9 and 10, the similarity relationships 88a, 88b, and 88c can establish relationships between the users 16a, 16b, and 16c, where the users 16b and 16c share a strong affinity relationship 88c between each other, and the user 16a shares a strongly opposing relationship 88a and 88b with the respective users 16b and 16c. As illustrated herein, the relationships between the users 16 as illustrated in FIG. 10 can be established by a single similarity value 88 based on a single comparison of comments written by two users.

The similarity relationships between users also can be based on an accumulation of the individual similarity values 88, for example in the case where the same users generate multiple comments at different instances, for example if all the users 16a, 16b and 16c also generated a second set of comments that are recorded relative to the position 84b. Hence, the similarity relationships between users can change over time depending on the number of comments that are compared between the two users.

Also note that the similar comment database 130 does not limit the accumulation of comments to a single asset 82; to the contrary, the indexing by users 16 enables multiple comment comparisons to be implemented across multiple assets, for example different videos, electronic books, etc., where the relationships also can be filtered by context, as appropriate. For example, the users 16a and 16b can have a strongly opposing relationship 88a in one context (e.g., politics), but a strong affinity relationship based on similar opinions in another context (e.g., sports teams, photography, etc.). In addition, relationships can change over time based on newer comments having changing opinions where users having opposing viewpoints in the past can develop shared opinions within the same context.

Hence, the similarity relationship 88a generated by the processor circuit 22 can establish the relationship between the users 16a and 16b based on the determined relationship between their respective comments 80a and 80b. Consequently, the processor circuit 22 within the server 18 (or any other server in the network 12 configured for executing socially collaborative filtering) can determine the in step 106 a relationship between the users 16a and 16b, as illustrated in FIG. 10, based on parsing the similar comment database 134 entries indexed by a particular user (e.g., 16a).

FIG. 11 illustrates an example method of executing socially collaborative filtering for a given user 16c based on applying similarity relationships 88 between other users, according to an example embodiment.

As described in detail in the commonly-assigned U.S. patent application Ser. No. 11/947,298, the network interface circuit 20 of the server 18 can update the user selection preferences 34 of FIG. 1 in response to each input by the user 16b based on identifying the user selection input relative to the input options presented to the user identifying the respective available items (i.e., the context of the corresponding user selection input), and any unselected input options indicating that the user 16b ignored these unselected input options. Hence, the processor circuit 22 can update the user selection preferences 34 in response to each input by the user 16, including identification of an input as a positive user selection input (a positive gesture) indicating the user 16 has a stronger affinity toward the corresponding selected input option (e.g., a strong positive opinion), a negative user selection input (a negative gesture) indicating the user 16 has a strong negative affinity (e.g., strong negative opinion) toward the corresponding selected input options 64.

The processor circuit 22 also can determine the context of the corresponding user selection input by also identifying input options within the presentation of available items that have been ignored by the user 16. Although the user selection of one item among multiple input options can result in the processor circuit 22 assigning a neutral gesture to the input options that were not selected, the repeated ignoring of input options by a user can cause the processor circuit to consider the multiple ignores as demonstrate ignore gestures toward the input options that repeatedly were not selected.

The updated user selection preferences 34 can be used by the processor circuit 22 to generate the item affinity values 54 for the user (“P1”) 16, illustrated in FIG. 3. Each item affinity value 54 demonstrates the relative “strength” of the user 16 toward a given network item (identified by its item identifier 58), where a higher value indicates a stronger relationship (a positive socially relevant gesture) 54a by the user 16 toward the corresponding item 58, a zero value indicates no preference (a neutral socially relevant gesture) 54b for the corresponding item 58 (for example, the item has been ignored), and a larger negative member indicates a stronger dislike (a negative socially relevant gesture) 54c by the user 16 toward the corresponding item 58. The processor circuit 22 also can generate user affinity values 56, illustrated in FIG. 4, for each relevant network item 62. The user affinity values 56 illustrated in FIG. 4 also can be updated without necessarily relying on the user selection preferences 34, for example in response to a detected user selection input that does not necessarily represent a “request” for an available network item.

Hence, the processor circuit 22 can identify a socially relevant gesture as increasing at least one item affinity value (also referred to as a positive socially relevant gesture) for example in response to a positive user selection input, decreasing at least one item affinity value (also referred to as a negative socially relevant gesture) for example in response to a negative user selection input, or generating little or no change in any item affinity value (also referred to as a neutral socially relevant gesture), described below.

A positive socially relevant gesture can be detected by the processor 22, for example, in response to a user 16 creating content, submitting positive comments on the content, providing a strong positive rating for the content (i.e., 5-star rating), or recommending the content to another user or to a group of users in an online community. Hence, example positive socially relevant gestures include a creation gesture that creates new network content, a comment gesture that inserts a comment into new or existing network content, a rate content gesture that provides a strong positive rating on the content, or a recommend content gesture that recommends the content to another user or group of users.

A neutral socially relevant gesture can be detected by the processor 22, for example, in response to a user 16 viewing the content, for example, for a brief interval indicating mild interest in the content (also referred to as a view gesture), or providing a neutral rating for the content, for example, 2-4 star rating out of a 1-5 star range (also referred to as a neutral rating gesture). Also note that the view gesture can be interpreted as either a positive socially relevant gesture, a neutral socially relevant gesture, or a negative socially relevant gesture, based on determining the duration of the viewing of the content as a percentage of the total duration of the content (for example, twenty percent or less is a negative socially relevant gesture, between twenty and seventy-five percent is a neutral socially relevant gesture, and above seventy-five percent is a positive socially relevant gesture).

A negative socially relevant gesture can be detected by the processor 22, for example, in response to a user 16 repeatedly ignoring content after multiple presentation offerings (also referred to as a multiple ignore gesture), submitting negative comments on the content or providing a strong negative rating, for example, a 1-star rating from the 5-star rating system (also referred to as a negative rating gesture), or abandoning viewing of the content (also referred to as an abandon view gesture).

Referring to FIG. 11, the processor circuit 22 can generate an ordered list of the closest network users (CNU) 140 that have the highest correlation of shared interests with the identified user (“Pc2”) 16b, based on identifying users sharing similar interests in similar items (e.g., users “Pr1”, “Pr2”, “Pc1”, “Prn”) as described in U.S. patent application Ser. No. 11/947,298, combined with adding the identified users 16a and 16c having the identified relationships 88a and 88c with the user 16b from the situational analysis of the comments described above with respect to FIGS. 5-10.

In particular, the processor circuit 22 can determine the group of closest network users (CNU) 140 based on identifying, from the available network items 58 that have been presented to the user 16b based on the respective input options, the ordered list of preferred network items (PNI) 120 having the highest relative item affinity values 54 generated for the identified user 16, as illustrated in FIG. 3 by the user-item relationships 48 indexed by the user “Pc2” 16b. As described previously, the item affinity value 54 for a network item 58 is generated and updated (for example, by the processor circuit 22) in response to detecting socially relevant gestures associated with the network item (for example, multiple user selection inputs for viewing the item, purchasing the item, supplying a “5-star” rating), but does not include any rating value submitted by the user. Note that the preferred network items 120 can include all of the available network items 58 presented to the user, ordered based on the respective item affinity values 54, such that the item (for example “C1”) having the highest item affinity value would be the first of the ordered list of preferred network items 120, and the item (for example, “Cn”) having the lowest item affinity value would be at the end of the ordered list of preferred network items 120.

Hence, the preferred network items 120 that have the highest relative item affinity values 54 for the corresponding identified user (“Pc2”) 16b can represent the available network items 58 for which the identified user (“Pc2”) 16b has expressed the highest interest. The preferred network items 120 can be filtered by the processor circuit 22 according to presentation context, as appropriate.

The processor circuit 22 also can identify the ordered list of closest network users (CNU) 140 based on identifying the network users 16 providing the highest relative user affinity values 56 for each of the preferred network items (PNI) 120 based on their respective user selection preferences 34. For example, the item “C2” 62 illustrated in FIG. 4 includes within its item-user relationships entry 52 in FIG. 4 the network users “Pc2”, “Pr1”, “Pr2”, “Pc1”, and “P377” having the respective user affinity values “337”, “301”, “297”, “−30”, and “−264” 56. As illustrated in FIG. 11, the network users “Pr1”, “Pr2”, and “Pc1” are added by the processor circuit 22 to the list of closest network users (CNU) 118 based on their respective relationships with the preferred network item “C2” (the user “P377” is not shown in FIG. 11, but also would be added within the ordered list 140): the processor circuit 22 can repeat the identification of network users providing the highest relative user affinity values, for each of the preferred network items (PNI) 120 based on retrieving the corresponding entry 52, resulting in the collection of the closest network users 118 that have the highest correlation of shared interests with the identified user (“P1”) 16.

As illustrated in FIG. 11, the user “Pr1” 16 has a positive affinity value 56a for the content “C1” 82, for example based on a favorable socially relevant gesture of watching the entire content. Unlike the users of FIGS. 5 and 9, however, the user “Pr1” of FIG. 11 did not generate a creation gesture for creation of a comment 80; hence, the user “Pr1” 16 is added to the list of closest network users based on his or her corresponding positive user affinity value 56a toward the content “C1” 82, generated for example based on the user “Pr1” viewing the content 82. As apparent from the foregoing description with respect to FIGS. 5-10, the user affinity value 56a between the content “C1” 82 and the user “Pr1” does not identify whether the user “Pr1” enjoyed the same portions of the content as the user “Pc2” 16b; in fact, the users “Pr1”, “Pc1” 16a, “Pc2” 16b, and “Pc3” 16c may have similar positive user affinity values 56 toward the overall content “C1”, despite the strongly differing opinions with respect to specific events within the content 82.

Hence, the similarity relationships 88c and 88a enable the respective users 16c and 16a to be added to the ordered list of users 140 based on the established relationships with the user 16b.

The list of the closest network users 118 also can be filtered based on presentation context as appropriate; hence, if the presentation context is photography, the processor circuit 22 can filter the network users that are not relevant to the presentation context, such that only the photography-related network users are accepted (as opposed to other network users that may share interests with the user 16b in sailing, politics, or history but that are unrelated to the presentation context of photography).

Following determination of the ordered list of network users 140, the processor circuit 22 can determine the preferred network items for each of the network users identified in the ordered list 140, based on the respective item affinity values 54 exhibited by the respective users according to their respective item affinity values (e.g., positive item affinity values 54a, neutral item affinity values 54b, or negative item affinity values 54c). The resulting set of the preferred network items for each of the network users in the ordered list 140 can be filtered to include only new network items not yet seen by the user “Pc2” 16b, resulting in a set of new network items (“Ci1”, “Ci2”, . . . “CiN”) 142 that are most likely to be preferred by the identified user “Pc2” 16b. Alternatively, the set 142 also can include network items that have been previously seen by the user, and/or content items or content assets that are stored locally on a user device and indexed within the network 12: the content items or content assets stored locally and that are identified in the set 142 can include new content assets that have not yet been consumed by the user 16b (for example, a content asset that has been “pushed” to a user device 14 according to a prescribed subscription, for example downloading the next movie in the user's subscription queue), and/or existing content assets that have already been seen or consumed by the user 16b. The identification of items “most likely to be preferred by the identified user” refers to those items determined as having the greatest probability of satisfying the user's interest (or preference) in content items or content assets that can be reachable via the network 12 or available locally on a user device such as the personal computer 14b. Hence, the network items 142 also can be referred to as the most “personally interesting content” to the user 16.

According to the example embodiments, similarity relationships can be established between users based on situational analysis of their comments relative to content consumed by the users, including determining positional similarity and content similarity between at least two comments. The established relationships can be used for generating an ordered list of network items most likely to be preferred by a user. The similarity relationships between users can be used for other applications, including demographic analysis including demographic clustering, etc..

While the example embodiments in the present disclosure have been described in connection with what is presently considered to be the best mode for carrying out the subject matter specified in the appended claims, it is to be understood that the example embodiments are only illustrative, and are not to restrict the subject matter specified in the appended claims.

What is claimed is:

1. A method comprising:
detecting a first comment that is input by a first user at an instance coincident with the first user having been supplied a first identified position of a content asset;
detecting a second comment that is input by a second user at an instance coincident with the second user having been supplied a second identified position of the content asset; and
selectively establishing a similarity relationship between the first and second users, based on a determined positional similarity between the first and second comments based on the respective first and second identified positions relative to the content asset, and a determined content similarity between the first and second comments.

2. The method of claim 1, wherein the first identified position and the second identified position are equal to each other and identify the same position of the content asset.

3. The method of claim 1, wherein the content asset is a media stream, the first identified position and the second identified position each specifying a corresponding timecode value of the media stream.

4. The method of claim 1, wherein the content asset is an electronic document, the first identified position and the second identified position each specifying a corresponding spatial position within the electronic document by at least one of page number, X-Y coordinates, or paragraph number.

5. The method of claim 1, wherein:
the detecting of the first comment includes recording the instance of the first user inputting the first comment based on storing a first database entry identifying the first comment and the corresponding first identified position of the content asset;
the detecting of the second comment includes recording the instance of the second user inputting the second comment based on storing a second database entry identifying the second comment and the corresponding second identified position of the content asset; and
the determining the positional similarity is based on a server retrieving the first and second database entries indexed based on the content asset.

6. The method of claim 5, wherein the determining the positional similarity is based on the respective first and second identified positions having a similarity in position relative to at least one of a prescribed threshold, or a dynamic threshold based on a population of stored comments.

7. The method of claim 5, wherein:
the detecting of the first comment further includes storing a third database entry identifying the first comment, the first user having input the first comment, and a corresponding content indicator specifying at least one of comment text, or a value indicating the first comment reflects one of a favorable or unfavorable opinion toward the content asset at the first identified position;
the detecting of the second comment further includes storing a fourth database entry identifying the second comment, the second user having input the second comment, and a corresponding content indicator specifying at least one of comment text, or a value indicating the second comment reflects one of a favorable or unfavorable opinion toward the content asset at the second identified position.

8. The method of claim 7, wherein the selectively establishing includes storing a fifth database entry specifying the similarity relationship between the first and second users in a database, the fifth database entry indexed by the first user.

9. The method of claim 1, wherein:
the selectively establishing includes storing a database entry specifying the similarity relationship between the first and second users in a database, the database entry indexed by the first user;
the method further comprising supplying the similarity relationship for determination of an ordered list of items most likely to be preferred by the first user, based on an identification of preferred items for the second user and not having been presented to the identified user.

10. A server comprising:
a processor circuit configured for:
detecting a first comment that is input by a first user at an instance coincident with the first user having been supplied a first identified position of a content asset,
detecting a second comment that is input by a second user at an instance coincident with the second user having been supplied a second identified position of the content asset, and
selectively establishing a similarity relationship between the first and second users, based on a determined positional similarity between the first and second comments based on the respective first and second identified positions relative to the content asset, and a determined content similarity between the first and second comments; and
a network interface circuit configured for outputting the similarity relationship for storage in a database.

11. The server of claim 10, wherein the first identified position and the second identified position are equal to each other and identify the same position of the content asset.

12. The server of claim 10, wherein the content asset is a media stream, the first identified position and the second identified position each specifying a corresponding timecode value of the media stream.

13. The server of claim 10, wherein the content asset is an electronic document, the first identified position and the second identified position each specifying a corresponding spatial position within the electronic document by at least one of page number, X-Y coordinates, or paragraph number.

14. The server of claim 10, wherein:
the server is configured for recording the instance of the first user inputting the first comment based on storing into the database a first database entry identifying the first comment and the corresponding first identified position of the content asset;
the server is configured for recording the instance of the second user inputting the second comment based on storing into the database a second database entry identifying the second comment and the corresponding second identified position of the content asset; and
the server is configured for determining the positional similarity based on retrieving the first and second database entries indexed based on the content asset.

15. The server of claim 14, wherein the server is configured for determining the positional similarity based on the respective first and second identified positions having a similarity in position relative to at least one of a prescribed threshold, or a dynamic threshold based on a population of stored comments.

16. The server of claim 14, wherein:
the server is configured for storing a third database entry identifying the first comment, the first user having input the first comment, and a corresponding content indicator specifying at least one of comment text, or a value indicating the first comment reflects one of a favorable or unfavorable opinion toward the content asset at the first identified position;
the server is configured for storing a fourth database entry identifying the second comment, the second user having input the second comment, and a corresponding content indicator specifying at least one of comment text, or a value indicating the second comment reflects one of a favorable or unfavorable opinion toward the content asset at the second identified position.

17. The server of claim 16, wherein the server is configured for storing in the database a fifth database entry specifying the similarity relationship between the first and second users, the fifth database entry indexed by the first user.

18. The server of claim 10, wherein:
the server is configured for storing in the database a database entry specifying the similarity relationship between the first and second users in a database, the database entry indexed by the first user;
the similarity relationship available for determination of an ordered list of items most likely to be preferred by the first user, based on an identification of preferred items for the second user and not having been presented to the identified user.

19. An apparatus comprising:
a network interface circuit configured for outputting data for storage in a database; and
means for detecting a first comment that is input by a first user at an instance coincident with the first user having been supplied a first identified position of a content asset;
the means for detecting further configured for detecting a second comment that is input by a second user at an instance coincident with the second user having been supplied a second identified position of the content asset;
the means for detecting further configured for selectively establishing a similarity relationship between the first and second users, based on a determined positional similarity between the first and second comments based on the respective first and second identified positions relative to the content asset, and a determined content similarity between the first and second comments, the means for detecting supplying the similarity relationship to the network interface circuit for storage in the database.

20. Logic encoded in one or more tangible media for execution and when executed operable for:
detecting a first comment that is input by a first user at an instance coincident with the first user having been supplied a first identified position of a content asset;
detecting a second comment that is input by a second user at an instance coincident with the second user having been supplied a second identified position of the content asset; and
selectively establishing a similarity relationship between the first and second users, based on a determined positional similarity between the first and second comments based on the respective first and second identified positions relative to the content asset, and a determined content similarity between the first and second comments.
